(19) United States
(12) Patent Application Publication
(10) Pub. No.: US 2026/0106801 A1
(43) Pub. Date: Apr. 16, 2026

(54) A SYSTEM AND METHOD FOR DIGITAL TWIN INTEGRATION IN IOT NETWORKS USED IN RURAL AREAS

(71) Applicant: BTS KURUMSAL BILISIM TEKNOLOJILERI ANONIM SIRKETI, Atasehir/Istanbul (TR)

(72) Inventors: Lal Verda ÇAKIR, Atasehir/Istanbul (TR); Tugçe BILEN, Istanbul (TR); Mehmet ÖZDEM, Çankaya/Ankara (TR); Berk CANBERK, Sariyer/Istanbul (TR); Gökhan YURDAKUL, Üsküdar/Istanbul (TR); Özgür PALANTÖKEN, Pendik/Istanbul (TR)

(21) Appl. No.: 19/116,342

(22) PCT Filed: Dec. 29, 2023
(86) PCT No.: PCT/TR2023/051862

§ 371 Date: Mar. 27, 2025

(30) Foreign Application Priority Data
Dec. 20, 2023 (TR) 2023/017801

(51) Int. Cl. H04L 41/14; G16Y 20/10; H04L 67/10; H04L 67/12

(52) U.S. Cl. CPC H04L 41/145; H04L 67/10; H04L 67/12; G16Y 20/10

(57) ABSTRACT

The invention relates to a system developed to improve the integration of IoT (Internet of Things) devices used in smart applications in locations far from urban areas, especially in rural areas, with digital twin (12) technology and a method for the operation of the system.

### TECHNICAL FIELD

The invention relates to a system developed to improve the integration of IoT (Internet of Things) devices used in smart applications in locations far from urban areas, especially in rural areas, with digital twin technology and a method for the operation of the system.

### STATE OF THE ART

Digital twin technologies are structures built based on a mechanism of real-time monitoring and control of an environment in which smart applications may be located. In addition, it is defined as virtual objects that are in continuous two-way communication with the physical counterpart thereof and are used in many different application areas.

In the present art, intelligent network control mechanisms are created with said digital twin technology. For example, in wireless network structures of an aircraft, new solutions are being developed to select a WIFI core network in real time and to prevent performance degradation caused by interference in wireless networks with multiple access points. The integration of these developed solutions into a physical environment is provided by means of a middleware mentioned in the studies. However, the method details of these middleware are excluded. This prevents the repeatability, reproducibility and real-life applicability of the developed solutions.

Digital twin solutions developed especially for agriculture are very rare in the state of the art. These include studies developed for animal breeding which have performance analysis deficiencies, failure to manage multiple data flows between the IoT and digital twin, and failure to support different communication protocols. In smart agriculture, the conditions in the physical environment are not suitable for the use of said cloud-based systems, as there is a wide wireless IoT network, different wireless technology infrastructures, and limited battery, processor and memory resources used in IoT devices. Considering the multiple data flows in digital twin structures, the computational burden caused by the number of preprocessing and processor cores required is ignored. This blocks the scalability of the system.

As mentioned, in the present art, there is no structure in which different technologies of said systems are applicable to each other. However, the integration of said systems is very necessary due to an IoT environment in a large farm and the inherent requirements of digital twins.

The focus was on the applicability problems of the IoT connectors in the past. In one of these studies [1], the unsolved problems of IoT technology were indicated and said that the studies in the literature are scenario-based and therefore cannot be scaled. This problem has been tried to be solved with an IoT middleware located in the edge network, but the effect of the proposed system on the network performance has not been addressed, and packet aggregation techniques to avoid this have not been explored. Although different IoT middleware is used for the digital twin and different systems are proposed, these studies do not meet the internal requirements of the digital twin technology for communication and are not suitable for farm scenarios.

In the state of the art and in order to eliminate the above-mentioned disadvantages, new systems and methods need to be developed.

### SUMMARY OF THE INVENTION

The present invention relates to a system and method which improves the integration of IoT (Internet of things) devices used in smart farm or agricultural applications with digital twin technology, in order to eliminate the above mentioned disadvantages and provide the related technical field with new advantages.

The system and method of the invention are especially aimed at applications desired to be made smart, where the electrical and network infrastructure may be weak, wireless IoT devices are used, and an automation process is performed.

The invention provides context-based communication according to the content of the data flowing there through, by keeping the self-knowledge of the IoT devices by the digital twin software module located in the IoT gateway modules in the IoT network generated in smart applications carried out in locations far from the urban areas. In addition, the invention supports different communication technologies such as WIFI, Zigbee, LoRa, and Bluetooth wireless communication, as well as MQTT, HTTP, CoAP, and AMQP protocols while said communication is performed. Thus, the invention is able to ensure interoperability between the devices with different technical specifications and solutions.

The invention allows the delay in communication to be minimized in order to increase the real-time characteristic of the communication between the IoT and the digital twin. Therefore, the data collected from the IoT devices is subject to packet aggregation as it passes through the IoT gateway. Here, the invention is able to both deliver higher priority data earlier under the framework of a context-based communication and prevent the expired packets ignored during the packet aggregation from occupying network resources by applying a customized packet aggregation method for the digital twin. This context-based communication characteristic is realized according to the criteria specified in the self-knowledge of the IoT devices. As the self-knowledge herein is kept in the IoT gateway module, the size of the packets transmitted between the IoT devices and the IoT gateway is reduced, and the delay is reduced when this packet aggregation method is included. In addition, thanks to the modular control structures included in the invention, the data reaching the IoT gateway through different wireless network communication methods is managed as a whole, and also, different application layer communication protocols that may be used by the developed applications are supported.

The system of the invention reduces the delays in communication between the IoT devices and the digital twin technology and provides connection sensitivity.

### DESCRIPTION OF THE DRAWINGS

Embodiments of the present invention, which are briefly summarized above and discussed in more detail below, may be understood by referring to the exemplary embodiments of the invention illustrated in the accompanying drawings. It should be noted, however, that the accompanying drawings only depict typical embodiments of this invention and are not to be construed as limiting the scope thereof.

FIG. 1. is a representative view of a diagram showing the principle of operation of the invention.

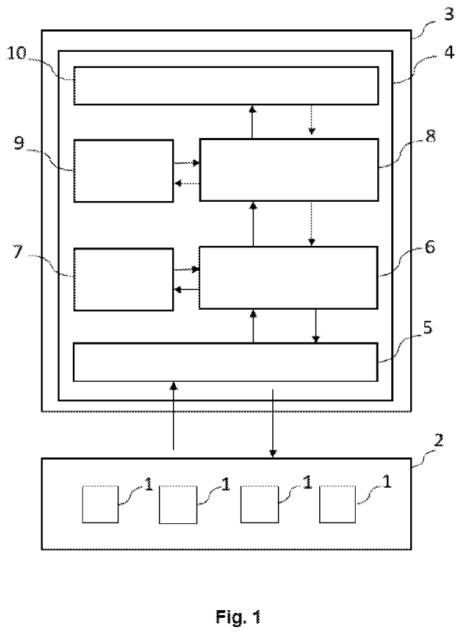

FIG. 2. is a representative view of a diagram showing the principle of operation of the method according to the invention.

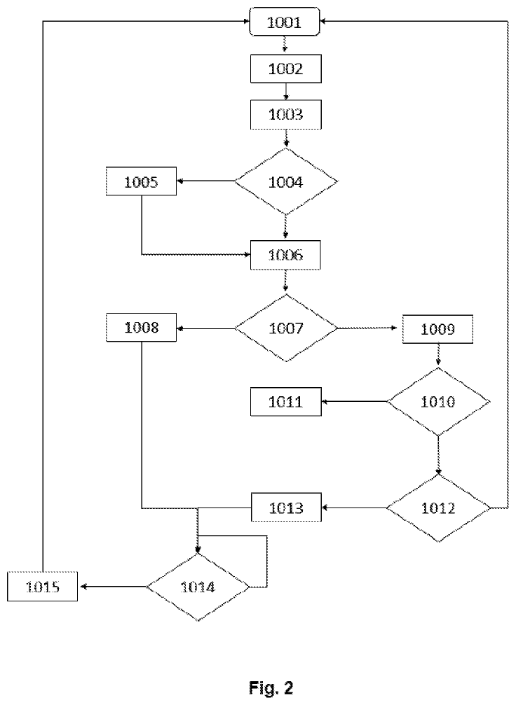

FIG. 3. is a representative view of a diagram showing the principle of operation of the method according to the invention.

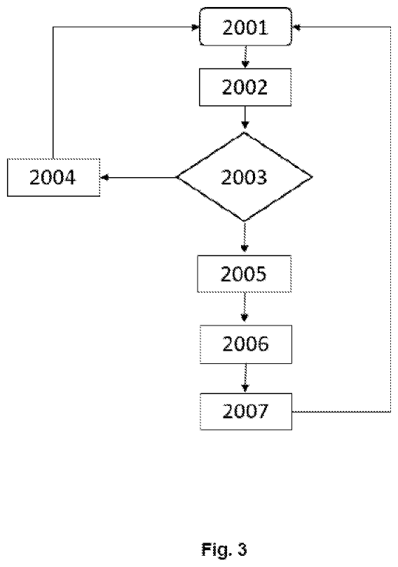

FIG. 4. is a representative view of a diagram showing the principle of operation of the invention.

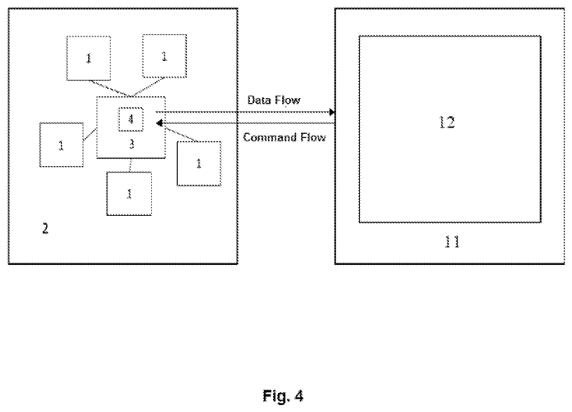

### DESCRIPTION OF THE REFERENCES IN THE DRAWINGS

In order to provide a better understanding of the invention, the numerals in the drawings are provided below:
1. IoT Device
2. IoT Network Module
3. IoT Gateway Module
4. Digital Twin Integration Module
5. Edge Network Communication Interface
6. Controller
7. Self-Knowledge Data Model (YANG Data Model)
8. Data Processing Server
9. Configuration Module
10. Cloud Interface
11. Cloud
12. Digital Twin
1001. Transforming the data read and collected from the environment in which it is located by the IoT device into a network packet and transferring the same to the edge network communication interface
1002. Discretizing the data content from the network packet transferred by the edge network communication interface and transmitting the same to the controller
1003. Updating the self-knowledge data model of the controller
1004. Checking the data according to the alarm conditions defined in the self-knowledge data model
1005. Signaling the data if the alarm conditions are met
1006. Transferring said signaled data to the data processing server
1007. Checking the data signals by the data processing server
1008. Assigning the data to a high priority queue if they are signaled
1009. if the data are not signaled, assigning them to at least one repository
1010. Detecting the other data assets, belonging to the IoT device sent at a previous time, of the data assigned to the repository
1011. When there exist other data, deleting said old data
1012. Checking the completion of the time interval, which is a parameter defined in the system, of the data assigned to the repository and controlled
1013. If the defined time interval is over, aggregating the data and assigning them to the less priority queue
1014. Checking the priority queue for data transmission adequacy and the communication channel of the IoT network
1015. Transferring the controlled data to the cloud interface and transmitting the same to the digital twin in the cloud
2001. Arriving the network packet sent by the digital twin at the IoT gateway module
2002. Discretizing the command content in the network packet by the edge network communication interface and transferring the command to the data processing server
2003. Checking the place where the command should be executed by the data processing server
2004. If it is a command sent for the IoT gateway module or digital twin integration module, then transmitting the same to the configuration module and executing the command by the configuration module
2005. If it is a command sent for the IoT device, then transmitting the same to the controller
2006. Transforming the command into a format that the device can understand, using the self-knowledge data model of the IoT device to which the command should be transmitted by the controller and transmitting the same to the edge network communication interface
2007. Transmitting the command to the IoT device using the IoT network communication channel between the edge network communication interface and the IoT device

### DETAILED DESCRIPTION OF THE INVENTION

Exemplary embodiments are described in more detail below with reference to the accompanying descriptions. However, embodiments may be constructed in different forms and should not be construed as limited to the embodiments set forth herein. Instead, these exemplary embodiments are provided for the completeness of this disclosure and to fully convey its scope to those skilled in the art.

The invention is a system which enables the integration of the IoT devices (1) used in smart applications executed in locations far from the urban areas with digital twin (12) technology using middleware requiring at least one processor, characterized in that it comprises:
at least one IoT device using IoT technology which allows data related the environment in which it is located to be collected and to be intervened in said environment (1),
at least one IoT network module (2) which may be connected to a wired network with the IoT gateway module (3) comprising the networks on which IoT devices (1) are built,
at least one IoT gateway module (3) located in the IoT network module (2),
at least one edge network communication interface (5) providing communication between the IoT device (1) and the IoT gateway module (3),
at least one controller (6) keeping the self-knowledge (YANG) data models (7) of IoT devices up-to-date and providing the contextual controls over the data using these models,
at least one self-knowledge data model (7) prepared to keep the structural properties and status values of the IoT devices (1),
at least one data processing server (6) that manages the sending of data sent by the controller (12) and the commands from the digital twin (1) to the IoT device (8),
at least one configuration module (9) responsible for the configurations for the IoT gateway module (3) and the digital twin integration module (4),
at least one cloud interface (10) that manages the communication in the connection between the IoT gateway module (3) and the digital twin (12) located in the cloud (11).

The system of the invention is kept up-to-date by the self-knowledge data model (7) contained therein and the model digital twin integration module (4) corresponding to each IoT device (1).

In an embodiment of the invention, the IoT device (1) is, but not limited to, temperature, humidity and air sensors, or an irrigation valve, or a water meter, or at least one greenhouse heating system.

In another embodiment of the invention, the IoT device (1) is, but not limited to, a GPS, a camera, an accelerometer, or a sensor in the smartphone.

The controller (6) included in the system of the invention manages the process of transferring the commands sent by the digital twin (12) for the IoT devices (1) to the devices and the data sent by the IoT devices (1) for the digital twin (12) to the cloud (11).

In digital twin-based smart applications executed in locations far from the urban areas, the data is periodically collected from the farm IoT network module (2), where the deployed IoT devices (1) are located. Said data collection process is performed through the IoT gateway module (3). In order to increase the quality of communication this data collection process, the method of the invention called contextual significance-based packet aggregation has been developed. The method and system the invention allow the network packet payloads to be combined under a network packet header using the method of the invention in order to prevent the fact that the ratio of the data in IoT traffic to the header in the network packet is low.

In the invention, the method for the operation of the system which enables the integration of the IoT devices (1) used in smart applications executed in locations far from the urban areas with digital twin (12) technology to be improved using middleware requiring at least one processor comprises the following process steps:
transforming the data read and collected from the environment in which it is located by the IoT device (1) into a network packet and transferring the same to the edge network communication interface (5) (1001)
discretizing the data content from the network packet transferred by the edge network communication interface (5) and transmitting the same to the controller (6) (1002)
updating the self-knowledge data model (7) by the controller (6) (1003)
checking the data according to the alarm conditions defined in the self-knowledge data model (7) (1004)
signaling (1005) the data if the alarm conditions are met, or if the conditions are not met, proceeding to the step (1006) of transferring the data signed directly to the data processing server (8),
transferring said signaled data to the data processing server (8) (1006)
checking the data signals by the data processing server (8) (1007)
if the data is signaled, assigning them to a high priority queue (1008) and proceeding to checking the priority queue and the communication channel of the IoT network for direct data transmission adequacy (1014),
if the data are not signaled, assigning the data to at least one repository (not shown in the drawings) (1009)
detecting the other data assets, belonging to the IoT device (1) sent at a previous time, of the data assigned to the repository (1010),
when there exist other data, deleting said old data (1011),
checking the completion of the time interval, which is a parameter defined in the system, of the data assigned to the repository and controlled (1012)
if the defined time interval is over, aggregating the data and assigning them to the low priority queue (1013), or if the defined time interval is not over, transforming the data read and collected from the environment in which it is located by the IoT device (1) into a network packet and transferring the same to the edge network communication interface (5) (1001)
checking the priority queue for data transmission adequacy and the communication channel of the IoT network (1014)
transferring the controlled data to the cloud interface (10) and transmitting the same to the digital twin (12) in the cloud (11) (1015).

In an embodiment of the invention, the defined alarm conditions in the step 1004 of the method may be defined in the self-knowledge data model (7). It varies depending on the area where the invention is applied and the choice of the people, who technically implement the invention, that is, the users.

In the system of the invention, the process steps of the method for transmitting the commands to the IoT devices (1) via the IoT gateway module (3) upon the integration of the IoT devices (1) with the digital twin technology are provided below:
arriving the network packet sent by the digital twin (12) at the IoT gateway module (3) (2001),
discretizing the command content in the network packet by the edge network communication interface (5) and transferring the command to the data processing server (8) (2002),
checking the place where the command should be executed by the data processing server (8) (2003),
if it is a command sent for the IoT gateway module (3) or digital twin integration module (4), then transmitting the same to the configuration module (9) and executing the command by the configuration module (9) (2004),
if it is a command sent for the IoT device (1), then transmitting the same to the controller (6) (2005),
transforming the command into a format that the device can understand, using the self-knowledge data model (7) of the IoT device (1) to which the command should be transmitted by the controller (6) and transmitting the same to the edge network communication interface (5) (2006),
transmitting the command to the IoT device (1) using the IoT network communication channel (not shown in the drawings) between the edge network communication interface (5) and the IoT device (1) (2007).

In the step 2002 of the method of the invention, the detailed inputs other than the commands in the network packets reaching the IoT gateway module (3) are removed from the system and the command content is discretized.

The method and system of the invention are developed using the IoT network module (2), and data is sent at regular intervals to check the temporal adequacy of the digital twin (12). In this case, the package aggregation should be done accordingly. However, due to the real-time convergence characteristic of the digital twin (12), multiple data belonging to the same device may be present while the data is waiting at the gateway. These network packets are called the expired network packets. In addition, digital twin (12) applications are used to perform automatic control over the system. In this case, packet aggregation, which will cause the data to wait, may also lead to the late arrival of the important network packets to the digital twin (12) and, subsequently, the devastating consequences. These disadvantages are eliminated by the contextual significance-based package aggregation using the digital twin software module (4), controller (6), self-knowledge data model (7) and data processing server (8) contained in the system and method of the invention.

The network packets are sent from the IoT devices (1) in the invention to the IoT gateway module (3) to which they are connected, and the data discretized from the incoming network packets is transferred to a repository. The data transferred to the repository is checked contextually, and the data with problems is signaled. Said signaled data is sent to the digital twin integration module (4) in a high-priority sequence before packet aggregation is implemented. Otherwise, the pooling process continues until the time interval, a parameter previously defined in said system, expires, and if there is data belonging to a device in the repository and a new one arrives, the old one is deleted. When the time interval expires, the data are combined under a network packet and placed in a low priority queue. These two important criterion queuing structures are transferred to the digital twin integration module (4) by a significance-based selection. In addition, there is provided a control flow from the digital twin (12) to the devices, apart from the data flow created between the digital twin (12) and the IoT devices (1) through the digital twin integration module (4). Said control flow is received from the digital twin (12) by the cloud interface (10), and MQTT (Message Queuing Telemetry Transport), HTTP (Hyper-Text Transfer Protocol), CoAP (Constrained Application Protocol) and AMQP (Advanced Message Queuing Protocol) protocols may be used. The commands transmitted to the cloud interface (10) are transferred to the data processing server (8), and the command is executed by being transferred to the command IoT gateway module (3), or to the configuration module (9) if it is sent for the digital twin integration module (4). If it is sent for IoT devices (1), the command transmitted to the controller (6) is sent to the interface (5) by being transformed into a form which may be understood by the IoT device (1) by means of the self-knowledge data model (7). The edge network interface (5) transmits this command through the communication channel it creates with the IoT device (1). Thus, digital twin integration with the IoT network is provided.

In self-knowledge data (YANG) models, drafts and models are created for any device. For example, in case there are 3 different status values, these parameters may be defined in a similar way to a tree model by specifying the data types in the form of a leaf within the scope of the definition as a list and the conditions indicated in the system or method. The flexibility required for the integration of different devices into the system is provided by the self-knowledge data (YANG) model (7) used in the method and system of the invention, and due to this tree structure, an organized and modular structure is obtained as the data and resources are kept in a hierarchical order.

All technical elements in the system and method of the invention perform the processes mentioned in the invention through the processor included in the computer via a software.

Any features described in this specification (including attached claims, abstract and drawings) may be replaced by other alternative features that may have equivalent or similar purposes, unless expressly stated otherwise. That is, unless explicitly stated otherwise, each feature is only one instance of a set of equivalent or similar features.

The terminology used in this specification is intended to be used only to describe a specific exemplary embodiment and is not intended to be restrictive. As used herein, the context of the forms “one”, “at least”, “preferably” and “and/or” also includes plural forms unless expressly stated otherwise. When the terms “contains” and/or “including” are used in this specification, they include the presence or addition of specified properties, integers, steps, operations, elements, and/or components, but do not preclude one or more other features, integers, steps, operations, elements, and/or components.

The above embodiments are intended only to describe the technical concept and characteristics of the present invention, and the object of the present invention is to enable the skilled one in the art to understand the content of the present invention and implement the present invention, and the scope of the present invention is not limited thereto. Equivalent alterations or modifications made in accordance with the spirit of the invention are intended to be included in the scope of the invention.

### INDUSTRIAL APPLICABILITY OF THE INVENTION

The invention relates to a system developed to improve the integration of IoT devices used in smart applications in locations far from urban areas, especially in rural areas, with digital twin (12) technology and a method for the operation of the system, and has an industrial applicability.

The invention is not limited to the above exemplary embodiments, and a person skilled in the art may easily present other different embodiments of the invention. These should be considered within the scope of protection of the invention claimed in the claims.

### REFERENCES

[1] M. Noura, M. Atiquzzaman, and M. Gaedke, “Interoperability in Internet of Things: Taxonomies and Open Challenges,” in Mobile Networks and Applications, vol. 24, pp. 796-809, 2019.

1. A system comprising at least one processor, which provides the integration of IoT devices (1) used in smart applications used in locations far from urban areas, especially in rural areas, with digital twin (12) technology, characterized in that it comprises;
at least one IoT device using IoT technology which allows data related the environment in which it is located to be collected and to be intervened in said environment (1),
at least one IoT network module (2) which may be connected to a wired network with the IoT gateway module (3) comprising the networks on which IoT devices (1) are built,
at least one IoT gateway module (3) located in the IoT network module (2),
at least one edge network communication interface (5) providing communication between the IoT device (1) and the IoT gateway module (3),
at least one controller (6) keeping the self-knowledge data models (YANG) (7) of IoT devices up-to-date and providing the contextual controls over the data using these models,
at least one self-knowledge data model (7) prepared to keep the structural properties and status values of the IoT devices (1),
at least one data processing server (6) that manages the sending of data sent by the controller (12) and the commands from the digital twin (1) to the IoT device (8),
at least one configuration module (9) responsible for the configurations for the IoT gateway module (3) and the digital twin integration module (4),
at least one cloud interface (10) that manages the communication in the connection between the IoT gateway module (3) and the digital twin (12) located in the cloud (11).

2. A system as in claim 1, characterized in that it comprises temperature, humidity and air sensors, or an irrigation valve, or a water meter, or an IoT device (1) which is at least one greenhouse heating system.

3. A method for the operation of the system comprising at least one processor, which provides the integration of IoT devices (1) used in smart applications used in locations far from urban areas with digital twin (12) technology, characterized in that it comprises the steps of:
transforming the data read and collected from the environment in which it is located by the IoT device (1) into a network packet and transferring the same to the edge network communication interface (5) (1001)
discretizing the data content from the network packet transferred by the edge network communication interface (5) and transmitting the same to the controller (6) (1002)
updating the self-knowledge data model (7) by the controller (6) (1003)
checking the data according to the alarm conditions defined in the self-knowledge data model (7) (1004)
signaling (1005) the data if the alarm conditions are met, or if the conditions are not met, proceeding to the step (1006) of transferring the data signed directly to the data processing server (8),
transferring said signaled data to the data processing server (8) (1006)
checking the data signals by the data processing server (8) (1007)
if the data is signaled, assigning them to a high priority queue (1008) and proceeding to checking the priority queue and the communication channel of the IoT network for direct data transmission adequacy (1014),
if the data are not signaled, assigning the data to at least one repository (not shown in the drawings) (1009)
detecting the other data assets, belonging to the IoT device (1) sent at a previous time, of the data assigned to the repository (1010),
when there exist other data, deleting said old data (1011),
checking the completion of the time interval, which is a parameter defined in the system, of the data assigned to the repository and controlled (1012)
if the defined time interval is over, aggregating the data and assigning them to the low priority queue (1013), or if the defined time interval is not over, transforming the data read and collected from the environment in which it is located by the IoT device (1) into a network packet and transferring the same to the edge network communication interface (5) (1001)
checking the priority queue for data transmission adequacy and the communication channel of the IoT network (1014)
transferring the controlled data to the cloud interface (10) and then transmitting to the digital twin (12) in the cloud (1015) (11).

4. A method as in claim 3, characterized in that it comprises the following steps in order to transmit the commands to the IoT devices (1) via the IoT gateway module (3) upon the integration of the system's IoT devices (1) with digital twin technology:
arriving the network packet sent by the digital twin (12) at the IoT gateway module (3) (2001),
discretizing the command content in the network packet by the edge network communication interface (5) and transferring the command to the data processing server (8) (2002),
checking the place where the command should be executed by the data processing server (8) (2003),
if it is a command sent for the IoT gateway module (3) or digital twin integration module (4), then transmitting the same to the configuration module (9) and executing the command by the configuration module (9) (2004),
if it is a command sent for the IoT device (1), then transmitting the same to the controller (6) (2005),
transforming the command into a format that the device can understand, using the self-knowledge data model (7) of the IoT device (1) to which the command should be transmitted by the controller (6) and transmitting the same to the edge network communication interface (5) (2006),
transmitting the command to the IoT device (1) using the IoT network communication channel (not shown in the drawings) between the edge network communication interface (5) and the IoT device (1) (2007).

5. A method as in claim 4, characterized in that a control flow from the digital twin (12) to the IoT devices (1) is carried out by the MQTT, HTTP, CoAP and AMQP protocols, apart from the data flow generated between the digital twin (12) through the digital twin integration module (4).
